(19) United States
(12) Patent Application Publication
(10) Pub. No.: US 2023/0085525 A1
(43) Pub. Date: Mar. 16, 2023

(54) HYPERBRANCHED POLYESTER POLYOLS SUITABLE FOR USE IN ORGANIC SOLVENT-BASED TWO-COMPONENT POLYURETHANE COATING COMPOSITIONS

(71) Applicant: BASF SE, Ludwigshafen am Rhein (DE)

(72) Inventors: Florian Ludwig GEYER, Ludwigshafen am Rhein (DE); Sebastian ROLLER, Ludwigshafen am Rhein (DE); Oliver NEU, Ludwigshafen am Rhein (DE)

(21) Appl. No.: 17/800,235

(22) PCT Filed: Feb. 10, 2021
(86) PCT No.: PCT/EP2021/053245

§ 371 Date: Aug. 17, 2022

(30) Foreign Application Priority Data
Feb. 20, 2020 (EP) 20158413.3

(51) Int. Cl. C08G 18/42; C08G 18/34; C08G 18/02

(52) U.S. Cl. CPC C08G 18/4261; C08G 18/341; C08G 18/022

(57) ABSTRACT

The present invention relates to polyester polyols comprising units derived from a) at least one COOH group or derivative thereof carrying component or mixture of components (A) comprising at least one compound carrying two COOH groups or derivatives thereof (A1), b) at least one OH group carrying component or mixture of components (B) comprising (i) at least one compound carrying three OH groups selected from the group consisting of 1,3,5-tris(hydroxymethyl)isocyanurate, 1,3,5-tris(2-hydroxyethyl) isocyanurate, 1,3,5-tris(2-hydroxyisopropyl)isocyanurate, 1,3,5-tris(2-hydroxypropyl)isocyanurate and 1,3,5-tris(2-hydroxybutyl)isocyanurate (B1), (ii) at least one compound carrying two OH groups selected from the group consisting of 1,1-bis(hydroxymethyl)-cyclohexane, 1,2-bis(hydroxymethyl)-cyclohexane, 1,3-bis(hydroxymethyl)-cyclohexane, 1,4-bis(hydroxymethyl)-cyclohexane, 1,1-bis(hydroxyethyl)-cyclohexane, 1,2-bis(hydroxyethyl)-cyclohexane, 1,3-bis(hydroxyethyl)-cyclohexane and 1,4-bis(hydroxyethyl)cyclohexane (B2), (iii) optionally at least one compound or polymer carrying at least three OH groups, which is different from B1 (B3), and (iv) optionally at least one compound or polymer carrying two OH groups, which is different from B2 (B4), and c) optionally at least one compound carrying at least one OH group and at least one COOH group or a derivative thereof (C), and to organic-solvent based two-component coating compositions comprising a) a first component (K1) comprising (i) at least one polyester polyol of the present invention and (ii) optionally at least one polymer carrying more than one OH group, which is different from the polyester polyol of the present invention (D), and b) a second component (K2) comprising (i) at least one compound, oligomer or polymer carrying more than one N═C═O group or blocked N═C═O group (F).

The present invention relates to hyperbranched polyester polyols, to solutions comprising at least one polyester polyol of the present invention, to organic-solvent based two-component coating compositions wherein one component comprises at least one polyester polyol of the present invention and to substrates coated with the coating composition of the present invention.

Organic solvent-based two-component polyurethane coating compositions are widely used in various applications, for example as coating for automobiles.

There is a continuing effort to increase the solid content in organic solvent-based two-component polyurethane coating compostions, which leads to a reduction of the amount of organic solvent, for environmental reasons.

In addition, organic solvent-based two-component polyurethane coating compositions of long gel time are preferred. The gel time is the time, at which the composition starts to gel after the two components have been mixed together. As the compositions can only be applied to a substrate before gelling starts, a long gel time allows for a longer operation window, also so-called “pot life”.

At the same time, the organic solvent-based two-component polyurethane coating compositions ideally also have a good drying behavior, and the coatings formed from the organic solvent-based two-component coating composition should show good mechanical properties.

US20090275680A1 describes hyperbranched polyesters obtainable by reacting at least one dicarboxylic acid, at least one diol and at least one x-valent alcohol or x-valent carboxylic acid, with x being a number greater than 2. US20090275680A1 also exemplifies organic-solvent based two-component coating compositions wherein one component comprises a hyper-branched polyester polyol. The exemplified organic-solvent based two-component compositions show a low non-volatile content.

US20110257329A1 describes a fast-drying two-component coating composition comprising (A) at least one polyisocyanate, (B) at least one hydroxy-group containing poly(meth)acrylate polyol and (C) at least one hyper-branched polyester polyol formed from at least one dicarboxylic acid, at least one at least 3-functional alcohol and optionally at least one diol, wherein less than 20 mol % of all OH-groups are derived from the diol.

US20180171174A1 describes fast-drying, energy-elastic, scratch-resistant and robust two-component coating compositions containing polyisocyanates, poly(meth)acrylate polyol, branched polyester polyols, wherein the polyester polyols are obtainable by condensation from hexahydrophthalic anhydride, trimethylolpropane and optionally further components such as dicarboxylic acids, tricarboxylic acids, diols and triols.

It was the object of the present invention to provide polyester polyols, which, when used in organic solvent-based two-component compositions, yield an organic solvent-based two-component compositions of high solid content and long gel time.

The polyester polyols of the present invention are polyester polyols comprising, preferably consisting of, units derived from
a) at least one COOH group or derivative thereof carrying component or mixture of components (A) comprising at least one compound carrying two COOH groups or derivatives thereof (A1),
b) at least one OH group carrying component or mixture of components (B) comprising
   (i) at least one compound carrying three OH groups selected from the group consisting of 1,3,5-tris(hydroxymethyl)isocyanurate, 1,3,5-tris(2-hydroxyethyl) isocyanurate, 1,3,5-tris(2-hydroxyisopropyl)isocyanurate, 1,3,5-tris(2-hydroxypropyl)isocyanurate and 1,3,5-tris(2-hydroxybutyl)isocyanurate (B1),
   (ii) at least one compound carrying two OH groups selected from the group consisting of 1,1-bis(hydroxymethyl)-cyclohexane, 1,2-bis(hydroxymethyl)-cyclohexane, 1,3-bis(hydroxymethyl)-cyclohexane, 1,4-bis(hydroxymethyl)-cyclohexane, 1,1-bis(hydroxyethyl)-cyclohexane, 1,2-bis(hydroxyethyl)-cyclohexane, 1,3-bis(hydroxyethyl)-cyclohexane and 1,4-bis(hydroxyethyl)-cyclohexane (B2),
   (iii) optionally at least one compound or polymer carrying at least three OH groups, which is different from B1 (B3), and
   (iv) optionally at least one compound or polymer carrying two OH groups, which is different from B2 (B4),
      and
c) optionally at least one compound carrying at least one OH group and at least one

COOH group or a derivative thereof (C).

Preferably, the polyester polyols of the present invention are polyester polyols obtainable by a process comprising the step of reacting
a) at least one COOH group or derivative thereof carrying component or mixture of components (A) comprising at least one compound carrying two COOH groups or derivatives thereof (A1),
b) at least one OH group carrying component or mixture of components (B) comprising (i) at least one compound carrying three OH groups selected from the group consisting of 1,3,5-tris(hydroxymethyl)isocyanurate, 1,3,5-tris(2-hydroxyethyl) isocyanurate, 1,3,5-tris(2-hydroxyisopropyl)isocyanurate, 1,3,5-tris(2-hydroxypropyl)isocyanurate and 1,3,5-tris(2-hydroxybutyl)isocyanurate (B1),
   (ii) at least one compound carrying two OH groups selected from the group consisting of 1,1-bis(hydroxymethyl)-cyclohexane, 1,2-bis(hydroxymethyl)-cyclohexane, 1,3-bis(hydroxymethyl)-cyclohexane, 1,4-bis(hydroxymethyl)-cyclohexane, 1,1-bis(hydroxyethyl)-cyclohexane, 1,2-bis(hydroxyethyl)-cyclohexane, 1,3-bis(hydroxyethyl)-cyclohexane and 1,4-bis(hydroxyethyl)-cyclohexane (B2),
   (iii) optionally at least one compound or polymer carrying at least three OH groups, which is different from B1 (B3), and
   (iv) optionally at least one compound or polymer carrying two OH groups, which is different from B2 (B4),
      and
c) optionally at least one compound carrying at least one OH group and at least one COOH group or a derivative thereof (C).

The at least one COOH group or derivative thereof carrying component or mixture of components (A), including component (A1), does not carry OH groups.

Component A1 is at least one compound carrying two COOH groups or a derivative thereof.

Compounds A1 carrying two COOH groups have preferably a molecular weight of below 500 g/mol, and most preferably of below 250 g/mol.

Compounds A1 carrying two COOH groups or derivatives thereof can be an aliphatic, alicyclic or aromatic compound carrying two COOH groups or derivatives thereof.

Aromatic compounds carrying two COOH groups are compounds carrying two COOH groups, wherein at least one COOH group is directly attached to an aromatic ring. Alicyclic compounds carrying two COOH groups are compounds carrying two COOH groups, which comprise at least one alicyclic ring and wherein each COOH group is not directly attached to an aromatic ring. Aliphatic compound carrying two COOH groups are compounds carrying two COOH groups, which comprise no alicyclic ring, and wherein each COOH group is not directly attached to an aromatic ring. Preferred aliphatic, alicyclic and aromatic compounds carrying COOH groups, exclusively consist, apart from the two COOH groups, of carbons and hydrogens.

Derivatives of the compounds carrying two COOH groups can be (i) the corresponding anhydride in monomeric or polymeric form, (ii) the corresponding mono- or di-O₁₋₄-alkyl-esters such as monomethyl ester, dimethyl ester, monoethylester, diethyl ester or mixed methyl ethyl esters (iii) the corresponding amides, or (iv) the corresponding acid halides such as chlorides or bromides.

Examples of C₁₋₄-alkyl are methyl, ethyl, propyl, isopropy, n-butyl, sec-butyl and tert-butyl.

Preferred derivatives of component (A1) are (i) the corresponding anhydride in monomeric form or (ii) the corresponding mono- or di-C₁₋₄-alkyl-esters.

Examples of aliphatic compounds carrying two COOH groups are oxalic acid, malonic acid, succinic acid, glutaric acid, adipic acid, pimelinic acid, suberic acid, azelaic caid, sebacic acid, 1,11-undecanedicarboxylic acid, 1,12-dodecanedicarboxlyic acid, maleic acid, fumaric acid, 2-methylmalonic acid, 2-ethylmalonic acid, 2-methylsuccinic acid, 2-ethylsuccinic acid, itaconic acid, 3,3-dimethylglutaric, 2-phenylmalonic acid and 2-phenylsuccinic acid,

Examples of alicyclic compounds carrying two COOH groups are cyclopentane-1,2-dicarboxylic acid, cyclopentane-1,3-dicarboxylic acid, cyclohexane-1,2-dicarboxylic acid, cyclohexane-1,3-dicarboxylic acid, cyclohexane-1,4-dicarboxylic acid, cycloheptane-1,2-dicarboxylic acid, 1,2-bis(carboxymethyl)-cyclohexane, 1,3-bis(carboxymethyl)-cyclohexane and 1,4-bis(carboxymethyl)-cyclohexane.

Examples of aromatic compounds carrying two COOH groups are phthalic acid, isophthalic acid, terephthalic acid and bis(4-carboxyphenyl) methane.

Preferably, component (A1) is at least one aliphatic or alicyclic compound carrying two COOH groups or a derivative thereof. More preferably, component (A1) is at least one alicyclic compound carrying two COOH groups or derivatives thereof. Even more preferably, component (A1) is at least one alicyclic compound carrying two COOH groups independently selected from the group consisting of cyclohexane-1,2-dicarboxylic acid, cyclohexane-1,3-dicarboxylic acid, cyclohexane-1,4-dicarboxylic acid and derivatives thereof. Most preferably, component (A1) is cyclohexane-1,2-dicarboxylic acid or a derivative thereof. In particular, component (A1) is cyclohexane-1,2-dicarboxylic acid anhydride.

The at least one COOH group or derivative thereof carrying component or mixture of components (A) can comprise further at least one COOH group carrying components, which are different from component (A1). Examples of these further at least one COOH group carrying components or derivatives thereof, which are different from component (A1), are aliphatic, alicyclic or aromatic compounds carrying at least three COOH groups and derivatives thereof. If component (A1) is, for example, in a preferred embodiment, an aliphatic or alicyclic compound carrying two COOH groups or a derivative thereof, it is to be understood, that aromatic compounds carrying two COOH groups or derivatives thereof are, in this preferred embodiment, regarded to be further at least one COOH group carrying components.

Examples of alicyclic compounds carrying three COOH groups are 1,3,5-cyclohexanetricarboxylic acid and aconitic acid. Examples of aromatic compounds carrying three COOH groups are 1,2,4-benzenetricarbocxylic acid and 1,3,5-benzenetricarbocxylic acid. An example of an aromatic compound carrying four COOH groups is 1,2,4,5-benzenetetracarboxylic acid. An example of an aromatic compound carrying six COOH groups is mellitic acid.

Derivatives of the at least one COOH group carrying components, which are different from component (A1), can be (i) the corresponding anhydride in monomeric or polymeric form, (ii) the corresponding mono- or di-C₁₋₄-alkyl-esters such as monomethyl ester, dimethyl ester, monoethylester, diethyl ester or mixed methyl ethyl esters (iii) the corresponding amides, or (iv) the corresponding acid halides such as chlorides or bromides.

An example of a derivative of an at least one COOH group carrying component, which is different from component (A1), is pyromellitic dianhydride.

The at least one OH group carrying mixture of components B, including components B1, B2, B3 and B4, do not carry COOH groups.

Preferably, component B1 is 1,3,5-tris(2-hydroxyethyl) isocyanurate.

Preferably, component B2 is selected from the group consisting of 1,4-bis(hydroxymethyl)cyclohexane and 1,4-bis(hydroxyethyl)-cyclohexane. More preferably, component B2 is 1,4-bis(hydroxymethyl)-cyclohexane.

Component B3 is a compound, oligomer or polymer carrying at least three OH groups, which is different from B1.

The compound, oligomer or polymer carrying at least three OH groups, which are different from B1, has preferably a molecular weight of below 1000 g/mol, more preferably of below 500 g/mol.

Examples of compounds, oligomer and polymers carrying at least three OH groups, which are different from B1, are aliphatic compounds carrying at least three OH groups such as glycerol, trimethylolmethane, 1,1,1-trimethylolethane, 1,1,1-trimethylolpropane, 1,2,4-butanetriol and pentaerythritol, condensates of aliphatic compounds carrying at least three OH groups such as diglycerol, triglycerole, condensates of at least four glycerols, di(trimethylolpropane) and di(pentaerythritol, condensates of aliphatic compounds carrying at least three OH groups, including component B1, with ethylene oxide, propylene oxide and/or butylene oxide, alicyclic compounds carrying at least three OH groups such as inositol, sugars such as glucose, fructose and sucrose, sugar alcohols such as sorbitol, mannitol, threitol, erythritol, adonitol (ribitol), arabitol (lyxitol), xylitol, dulcitol (galactitol), malitol and isomalt, as well as tris(hydroxymethyl)amine, tris(hydroxyethyl)amine and tris(hydroxypropyl)amine.

Alicyclic compounds carrying at least three OH groups are compounds carrying at least three OH groups, which comprise at least one alicyclic ring and wherein each OH group is not directly attached to an aromatic ring. Aliphatic compound carrying at least three OH groups are compounds carrying at least three OH groups, which comprise no alicyclic ring, and wherein each OH group is not directly attached to an aromatic ring. Preferred aliphatic and alicyclic compounds carrying at least three OH groups, exclusively consist, apart from the the OH groups, of carbons and hydrogens, and do not comprise aromatic rings.

In one embodiment, the compound, oligomer or polymer carrying at least three OH groups, which is different from B1, is independently selected from the group consisting of aliphatic compounds carrying at least three OH groups, condensates of aliphatic compounds carrying at least three OH groups and condensates of aliphatic compounds carrying at least three OH groups, including component B1, with ethylene oxide, propylene oxide and/or butylene oxide.

In a particular embodiment, the compound, oligomer or polymer carrying at least three OH groups, which is different from B1, is independtly an aliphatic compound carrying at least three OH groups, for example 1,1,1-trimethylolpropane.

Component B4 is a compound, oligomer or polymer carrying two OH groups, which is different from B2.

Component B4 which is compound carrying two OH has preferably a molecular weight of below 1000 g/mol, more preferably of below 500 g/mol, and most preferably of below 250 g/mol.

Preferably, component B4 which is compound carrying two OH is an aliphatic or alicyclic compound carrying two OH groups.

Alicyclic compounds carrying two OH groups are compounds carrying two OH groups, which comprise at least one alicyclic ring and wherein each OH group is not directly attached to an aromatic ring. Aliphatic compounds carrying two OH groups are compounds carrying two OH groups, which comprise no alicyclic ring, and wherein each OH group is not directly attached to an aromatic ring. Preferred aliphatic and alicyclic compounds carrying two OH groups, exclusively consist, apart from the the OH groups, of carbons and hydrogens, and do not comprise aromatic rings.

Examples of aliphatic compounds carrying two OH groups, which are different from B2, are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, heptane-1,7-diol, octane-1,8-diol, octane-1,2-diol, nonane-1,9-diol, decane-1,2-diol, decane-1,10-diol, dodecane-1,2-diol, dodecane-1,12-diol, hexa-1,5-diene-3,4-diol, neopentyl glycol, 2-methyl-pentane-2,4-diol, 2,4-dimethylpentane-2,4-diol, 2-ethyl-hexane-1,3-diol, 2,5-dimethyl-hexane-2,5-diol, 2,2,4-tri methyl-pentane-1,3-diol, pinacol and hydroxypivalinic acid neopentyl glycol ester

Examples of alicyclic compounds carrying two OH groups, which are different from B2, are 2,2,4,4-tetramethyl-1,3-cyclobutandiol, cyclopentane-1,2-diol, cyclopentane-1,3-diol, 1,2-bis(hydroxymethyl) cyclopentane, 1,3-bis(hydroxymethyl) cyclopentane, cyclohexane-1,2-diol, cyclohexane-1,3-diol, cyclohexane-1,4-diol, cycloheptane-1,3-diol and cycloheptane-1,4-diol and cycloheptane-1,2-diol.

Component B4, which is an oligomer or polymer carrying two OH groups, has preferably a molecular weight of below 5000 g/mol, more preferably of below than 1000 g/mol, even more preferably of below 500 g/mol.

Examples of oligomers and polymers carrying two OH groups are polyether diols and polyester diols.

Examples of polyether diols are diethylene glycol, triethylene glycol, dipropylene glycol, tripropylene glycol, polyethylene glycols HO(CH₂CH₂O)ₙ—H, polypropylene glycols HO(CH(CH₃)—CH₂—O)ₙ—H, n being an integer and n>=4, polyethylene-polypropylene glycols, the sequence of the ethylene oxide or propylene oxide units being blockwise or random, polytetramethyleneglycols, and polytetrahydrofurane.

Examples of polyester diols are polycaprolactons.

Component C is at least one compound carrying at least one OH group and at least one COOH group or a derivative thereof.

Derivatives of the compounds carrying at least one OH group and at least one COOH group can be (i) the corresponding anhydride in monomeric or polymeric form, (ii) the corresponding mono- or di-C₁₋₄-alkyl-esters such as monomethyl ester, dimethyl ester, monoethylester, diethyl ester or mixed methyl ethyl esters or (iii) intramolecular cyclic esters of the compounds carrying at least one OH groups and at least one COOH group.

The compounds carrying at least one OH group and at least one COOH preferably have a molecular weight of below 500 g/mol, and most preferably of below 250 g/mol.

The compound carrying at least one OH group and at least one COOH group or derivative thereof can be an aliphatic, alicyclic or aromatic compound carrying at least one OH group and at least one COOH group or a derivative thereof.

Aromatic compounds carrying at least one OH group and at least one COOH group are compounds carrying at least one OH group and at least one COOH group, wherein at least one OH group or COOH group is directly attached to an aromatic ring. Alicyclic compounds carrying at least one OH group and at least one COOH group are compounds carrying at least one OH group and at least one COOH group, which comprise at least one alicyclic ring and wherein each OH group and each COOH group is not directly attached to an aromatic ring. Aliphatic compound carrying at least one OH group and at least one COOH group are compounds carrying at least one OH group and at least one COOH group, which comprise no alicyclic ring, and wherein each OH group and each COOH group is not directly attached to an aromatic ring. Preferred aliphatic, alicyclic and aromatic compounds carrying at least one OH group and at least one COOH group, exclusively consist, apart from the OH groups and COOH groups, of carbons and hydrogens.

Examples of compounds carrying at least one OH group and at least one COOH group are compounds carrying one OH group and one COOH group or derivatives thereof and compounds carrying two OH groups and one COOH group or derivatives thereof.

Examples of aliphatic compounds carrying two OH groups and one COOH group are dimethylolpropionic acid or dimethylolbutyric acid.

Preferably, the compound carrying at least one OH group and at least one COOH group is a compound carrying one OH group and one COOH group or derivatives thereof.

In a preferred embodiment, the polyester polyols of the present invention are polyester polyols comprising, preferably consisting of, units derived from
a) at least one COOH group or derivative thereof carrying component or mixture of components (A) consisting of at least one compound carrying two COOH groups or derivatives thereof (A1),
b) at least one OH group carrying component or mixture of components (B) consisting of
   (i) at least one compound carrying three OH groups selected from the group consisting of 1,3,5-tris(hydroxymethyl)isocyanurate, 1,3,5-tris(2-hydroxyethyl) isocyanurate, 1,3,5-tris(2-hydroxyisopropyl)isocyanurate, 1,3,5-tris(2-hydroxypropyl)isocyanurate, and 1,3,5-tris(2-hydroxybutyl)isocyanurate (B1),
   (ii) at least one compound carrying two OH groups selected from the group consisting of 1,1-bis(hydroxymethyl)-cyclohexane, 1,2-bis(hydroxymethyl)-cyclohexane, 1,3-bis(hydroxymethyl)-cyclohexane, 1,4-bis(hydroxymethyl)-cyclohexane, 1,1-bis(hydroxyethyl)-cyclohexane, 1,2-bis(hydroxyethyl)-cyclohexane, 1,3-bis(hydroxyethyl)-cyclohexane and 1,4-bis(hydroxyethyl)-cyclohexane (B2),
   (iii) optionally at least one compound, oligomer or polymer carrying at least three OH groups, which is different from B1 (B3), and
   (iv) optionally at least one compound, oligomer or polymer carrying two OH groups, which is different from B2 (B4),
      and
c) optionally at least one OH group and at least one COOH group carrying component or mixture of components or derivatives thereof (C), wherein the compound carrying at least one OH group and at least one COOH group is a compound carrying one OH group and one COOH group.

In more preferred embodiment, the polyester polyols of the present invention are polyester polyols comprising, preferably consisting of, units derived from
a) at least one COOH group or derivative thereof carrying component or mixture of components (A) consisting of at least one compound carrying two COOH groups or derivatives thereof (A1),
b) at least one OH group carrying component or mixture of components (B) consisting of
   (i) at least one compound carrying three OH groups selected from the group consisting of 1,3,5-tris(hydroxymethyl)isocyanurate, 1,3,5-tris(2-hydroxyethyl) isocyanurate, 1,3,5-tris(2-hydroxyisopropyl)isocyanurate, 1,3,5-tris(2-hydroxypropyl) isocyanurate- and 1,3,5-tris(2-hydroxybutyl)isocyanurate (B1),
   (ii) at least one compound carrying two OH groups selected from the group consisting of 1,1-bis(hydroxymethyl)-cyclohexane, 1,2-bis(hydroxymethyl)-cyclohexane, 1,3-bis(hydroxymethyl)-cyclohexane, 1,4-bis(hydroxymethyl)-cyclohexane, 1,1-bis(hydroxyethyl)-cyclohexane, 1,2-bis(hydroxyethyl)-cyclohexane, 1,3-bis(hydroxyethyl)-cyclohexane and 1,4-bis(hydroxyethyl)-cyclohexane (B2),
   (iii) optionally at least one compound, oligomer or polymer carrying at least three OH groups, which is different from B1 (B3), and
   (iv) optionally at least one compound, oligomer or polymer carrying two OH groups, which is different from B2 (B4).

The ratio of the sum of mol OH groups derived of all components B and C to the sum of mol COOH groups derived from all components A and C can be in the range of 50 to 250%. It is preferably in the range of 80 to 200%, more preferably in the range of 120% to 200%, even more preferably in the range of 130% to 170% and most preferably in the range of 140% to 150%.

The ratio of the sum of mol COOH groups derived from component A1 to the sum of mol COOH groups derived from all components A and C can be in the range of 50% to 100%. It is preferably in the range of 70% to 100%, more preferably in the range of 80% to 100%, even more preferably in the range of 90% to 100%, and most preferably in the range of 95% to 100%.

The ratio of the sum of mol COOH groups derived from component A1 in the form of the corresponding anhydride to the sum of mol COOH groups derived from all components A and C can be in the range of 0 to 100%. It is preferably in the range of 50 to 100%, more preferably in the range of 80% to 100%, even more preferably in the range of 90% to 100%, and most preferably in the range of 95% to 100%.

The ratio of the sum of mol OH groups derived from components B1 and B2 to the sum of mol OH groups derived from all components B and C can be in the range of 5% to 100%. It is preferably in the range of 20% to 100%, more preferably in the range of 40% to 100%, even more preferably in the range of 50% to 100%, most preferably in the range of 60% to 100%.

The ratio of mol OH groups derived from component B1 to the sum of mol OH groups derived from components B1 and B3 can be in the range of 5% to 100%. It is preferably in the range of 20 to 100%, more preferably in the range of 35% to 100%, and most preferably in the range of 45% to 100%.

The ratio of mol OH groups derived from component B1 to the sum of mol OH groups derived from all components B and C can be in the range of 5 to 96%. It is preferably in the range of 10 to 96%, more preferably in the range of 15 to 95%, and most preferably in the range of 35 to

The ratio of the sum of mol OH groups derived from components B2 to the sum of mol OH groups derived from components B2 and B4 can be in the range of 5% to 100%. It is preferably in the range of 30% to 100%, more preferably in the range of 60% to 100%, even more preferably in the range of 80% to 100%, most preferably in the range of 95% to 100%.

The ratio of the sum of mol OH groups derived from components B2 to the sum of mol OH groups derived from all components B and C can be in the range of 5% to 80%. It is preferably in the range of 10% to 60%, more preferably in the range of 15% to 40%, even more preferably in the range of 20% to 35%, most preferably in the range of 22% to 30%.

The ratio of mol OH groups derived from from component B1 to mol OH groups derived from components B2 can be in the range of 5% to 2000%. It is preferably in the range of 10% to 1000%, more preferably in the range of 25% to 700% and most preferably in the range of 50% to 500%.

The mol COOH groups derived from one of the components A and C, respectively, is defined as mol component A and C, respectively, used in the in the step of reacting at least one component A, at least one component B and optionally at least one component C, multiplied by the number of COOH groups carried or derived from component A and C, respectively. For example, 2 mol COOH groups are derived from 1 mol cyclohexane-1,2-dicarboxylic anhydride, which is a component A1. For example, 4 mol COOH groups are derived from 2 mol cyclohexane-1,2-dicarboxylic anhydride, which is a component A1.

The mol OH groups derived from one of the components B and C, respectively, is defined as mol component B and C, respectively, used in the step of reacting at least one component A, at least one component B and optionally at least one component C, multiplied by the number of OH groups carried by component B and C, respectively. For example, 3 mol OH groups are derived from 1 mol 1,3,5-tris(2-hydroxyethyl) isocyanurate, which is a component B1. For example, 2 mol OH groups are derived from 1 mol 1,4-bis(hydroxymethyl)-cyclohexane, which is a component B2. For example, 3 mol OH groups are derived from 1 mol 1,1,1-trimethylolpropane, which is a component B3.

For example, a polyester polyol comprising units derived from

cyclohexane-1,2-dicarboxylic anhydride, which is a component A1,
1,3,5-tris(2-hydroxyethyl) isocyanurate, which is a component B1,
1,4-bis(hydroxymethyl)-cyclohexane, which is a component B2, and
1,1,1-trimethylolpropane, which is a component B3,
and which polyester polyol is obtainable by a pocess comprising the step of reacting
2.0 mol cyclohexane-1,2-dicarboxylic anhydride, which is a component A1,
0.75 mol 1,3,5-tris(2-hydroxyethyl) isocyanurate, which is a component B1,
0.75 mol of 1,4-bis(hydroxymethyl)-cyclohexane, which is a component B2, and
0.75 mol of 1,1,1-trimethylolpropane, which is a component B3, has
a ratio of the sum of mol OH groups derived from components B and C to the sum of mol COOH groups derived from components A and C of 150%,
a ratio of the sum of mol COOH groups derived from components A1 to the sum of mol COOH groups derived from components A and C of 100%,
a ratio of the sum of mol OH groups derived from components B1 and B2 to the sum of mol OH groups derived from components B and C of 62.5%,
a ratio of mol OH groups derived from component B1 to the sum of mol OH groups derived from components B1 and B3 of 50%,
a ratio of mol OH groups derived from component B1 to the sum of mol OH groups derived from all components B and C of 37.5%,
a ratio of mol OH groups derived from component B2 to the sum of mol OH groups derived from components B2 and B4 of 100%,
a ratio of mol OH groups derived from component B2 to the sum of mol OH groups derived from all components B and C of 25%, and
a ratio of mol OH groups derived from component B1 to mol OH groups derived from component B2 of 150%.

The polyester polyols of the present invention are so-called “hyperbranched” polyester polyols. “Hyperbranched” polyester polyols are defined to be polyester polyols of tree-like structure comprising non-terminal monomer units derived from component A, B and optionally C, respectively, which have more than two groups individually selected from the group consisting of OH group, COOH group and derivative thereof, wherein at least one of these groups has not reacted to form a linkage between two monomer units individually derived from component A, B and optionally C. Preferably, the molar ratio of non-terminal monomer units derived from component A, B and optionally C, respectively, which have more than two groups individually selected from the group consisting of OH group, COOH group and derivative thereof, wherein at least one of these groups has not reacted to form a linkage between two monomer units individually derived from component A, B and optionally C to non-terminal monomer units derived from component A, B and optionally C, respectively, which have more than two groups individually selected from the group consisting of OH group, COOH group and derivative thereof, wherein all of these groups have reacted to form a linkage between two monomer units individually derived from component A, B and optionally C is at least 5/95, more preferably at least 10/90, even more preferably at least 30/70. This molar ratio can be determined by methods known in the art, for example ¹³C-NMR and titration. The method or combination of methods depend on components A, B and C, and a person skilled in the art knows which methods to choose.

The polyester polyols of the present invention preferably have a hydroxyl number in the range of 50 to 400 mg KOH/g, more preferably in the range of 100 to 300 mgKOH/g, even more preferably in the range of 110 to 200 mg KOH/g, most preferably in the range of 120 to 190 KOH/g. The hydroxyl number is determined according to DIN 53240, 2016.

The polyester polyols of the present invention preferably have an acid number in the range of 1 to 200 mg KOH/g, more preferably in the range of 1 to 100 mgKOH/g, and most preferably in the range of 1 to 50 mg KOH/g. The acid number is determined according to DIN 53402, 1990.

The polyester polyols of the present invention preferably have a number average molecular weight Mn in the range of 400 to 50000 g/mol, more preferably in the range of 400 to 10000 g/mol, even more preferably in the range of 500 to 5000 g/mol and most preferably in the range of 600 to 4000 g/mol. The number average molecular weight Mn is determined using gel permeation chromatography calibrated to a polystyrene standard.

The polyester polyols of the present invention preferably have a weight average molecular weight Mw in the range of 500 to 50000 g/mol, more preferably in the range of 800 to 30000 g/mol and most preferably in the range of 1000 to 25000 g/mol. The weight average molecular weight Mn is determined using gel permeation chromatography calibrated to a polystyrene standard.

The polyester polyols of the present invention preferably have a polydispersity Mw/Mn in the range of 1.1/1.0 to 40.0/1.0, more preferably in the range of 1.2/1.0 to 20.0/1.0 and most preferably in the range of 1.5/1.0 to 10.0/1.0.

The step of reacting component (A), component (B) and optionally component (C) is a polyesterification reaction.

The reaction can be be carried out in the presence or absence of solvent. Examples of suitable solvents include hydrocarbons such as n-heptane, cyclohexene, toluene, ortho-xylene, metaxylene, para-xylene, xylene isomer mixture, ethylbenzene, chlorobenzene, ortho- and metadichlorobenzene. Of further suitability as solvents in the absence of acidic catalysts are ethers such as dioxane or tetrahydrofuran, and ketones such as methyl ethyl ketone and methyl isobutyl ketone. Preferably, the reaction is carried out in the absence of solvent.

Preferably, the water formed in the course of the reaction is removed continuously during the reaction. Water can be removed by distillation. Water can also be removed by stripping, which comprises passing a gas, which is inert under the reaction conditions, such as nitrogen, through the reaction mixture. Water can also be removed by performing the reaction in the presence of a water-removing agent such as MgSO₄ and Na₂SO₄. It is also possible to combine the described methods for removal of water. Preferably, water is removed by distillation, optionally in combination with other water-removal methods.

If other volatile components, for example methanol or ethanol, are also formed in the course of the reaction, these can also be removed by distillation or stripping.

Preferably the reaction is performed in the absence of a catalyst. However, it is also possible to perform the reaction in the presence of at least one catalyst. The catalyst can be selected from the group consisting of acidic inorganic, acidic organometallic and acidic organic catalysts or mixtures thereof.

Examples of acidic inorganic catalysts are sulfuric acid, sulfates and hydrogen sulfates such as sodium hydrogen sulfate, phosphoric acid, phosphonic acid, hypophosphoric acid aluminium sulfate hydrate, alum, acidic silica gel (pH<=6, especially pH<=5) and acidic aluminium oxide.

Examples of acidic organometallic catalysts are organic aluminium catalysts such as tris(nbutyloxy)aluminium, tris(isopropyloxy)aluminium and tris(2-ethylhexoxy)aluminium, as well as organic titan catalysts such as tetra(n-butyloxy)titan, tetra(isopropyloxy)titan and tetra(2-ethylhexoxy)titan, organic tin catalysts such as dibutyltin oxide, diphenyltin oxide, dibutyltin dichloride, tin(II)di(n-octanoate), tin(II) di(2-ethylhexanoate), tin(II) laurate, dibutyltin diacetate, dibutyltin dilaurate, dibutyltin dimaleate and dioctyltin diacetate as well as organic zinc catalysts such as zinc acetate.

Examples of acidic organic catalysts are organic compounds containing phosphate groups, sulfonic acid groups, sulfate groups or phosphonic acid groups, such as para-toluene sulfonic acid. Further examples of acidic organic catalysts are acidic ion exchangers such as polystyrene resins being crosslinked with divinylbenzene and containing sulfonic acid groups.

Preferably, the reaction is carried out under a gas, which is inert under the reaction conditions. Suitable inert gases include nitrogen, noble gases such as argon, carbon dioxide or combustion gases.

The reaction can be performed at a pressure in the range of 10 mbar to 10 000 mbar, preferably at a pressure in the range of 10 to 2000 mbar, more preferably at a pressure in the range of 10 to 1200 mbar, most preferably at a pressure in the range of 300 to 1100 mbar.

The temperature at which the reaction of components (A), (B) and optionally (C) is performed dependents on the pressure under which the reaction is performed.

The temperature is usually in the range of 60 to 250° C., preferably, in the range of 100 to 220° C. and more preferably in the range of 120 to 200° C. It is preferred that the temperature increases during the polyesterifcation reaction.

The reaction can be monitored by the titration of the hydroxyl number or the acid number. Usually, the reaction is stopped, when the target hydroxyl or acid number of the polyester polyol is reached, by cooling the reaction mixture, preferably to below 100° C., more preferably to below 90° C., to yield the final reaction mixture comprising the polyester polyol.

If the reaction is performed in the absense of a catalyst and solvent, the final reaction mixture essentially consists of polyester polyol.

If the reaction is performed in the presence of at least one catalyst and/or a solvent, the polyester polyol of the present invention can be isolated, if desired, from the final reaction mixture, for example, by filtering off the catalyst and/or removing the solvent, for example by distillation or stripping, preferably under reduced pressure. Alternatively, instead of removing the solvent, the polyester polyol can be isolated by adding water to the final reaction mixture and filtering off the precipitated polyester polyol.

The crude polyester polyol can be further worked-up, if necessary, by standard methods known in the art, for example by dissolution in an organic solvent, followed by washing, for example with water, aqueous sodium chloride solution or aqueous sodium hydroxide or sodium hydrogencarbonate solution, followed by removal of the organic solvent or precipitation with water, and drying.

Also part of the present invention is a process for the preparation of the polyester polyols of the present invention which comprises the step of reacting
a) at least one COOH group or derivative thereof carrying component or mixture of components (A) comprising at least one compound carrying two COOH groups or derivatives thereof (A1),
b) at least one OH group carrying component or mixture of components (B) comprising
   (i) at least one compound carrying three OH groups selected from the group consisting of 1,3,5-tris(hydroxymethyl)isocyanurate, 1,3,5-tris(2-hydroxyethyl) isocyanurate, 1,3,5-tris(2-hydroxyisopropyl)isocyanurate, 1,3,5-tris(2-hydroxypropyl)isocyanurate and 1,3,5-tris(2-hydroxybutyl)isocyanurate (B1),
   (ii) at least one compound carrying two OH groups selected from the group consisting of 1,1-bis(hydroxymethyl)-cyclohexane, 1,2-bis(hydroxymethyl)-cyclohexane, 1,3-bis(hydroxymethyl)-cyclohexane, 1,4-bis(hydroxymethyl)-cyclohexane, 1,1-bis(hydroxyethyl)-cyclohexane, 1,2-bis(hydroxyethyl)-cyclohexane, 1,3-bis(hydroxyethyl)-cyclohexane and 1,4-bis(hydroxyethyl)-cyclohexane (B2),
   (iii) optionally at least one compound or polymer carrying at least three OH groups, which is different from B1 (B3), and
   (iv) optionally at least one compound or polymer carrying two OH groups, which is different from B2 (B4),
      and
c) optionally at least one compound carrying at least one OH group and at least one COOH group or a derivative thereof (C).

Also part of the present invention are solutions comprising at least one polyester polyol of the present invention and at least one organic solvent. Suitable organic solvents are esters, ketones, amides, ethers and aromatic hydrocarbons and mixtures thereof.

Examples of esters of are ethyl acetate, butyl acetate, 1-methoxy-2-propyl acetate, 2-butoxy ethyl acetate (butyl gycol acetate), propylene glycol diacetate, ethyl 3-ethoxypropionate, 3-methoxybutyl acetate, butyldiglycol acetate and propylene carbonate. Examples of ketones are acetone, methyl ethyl ketone and methyl isobutyl ketone. Examples of amides are dimethylformamide (DMF) and N-methyl pyrrolidone (NMP). Example of ethers are glycol ethers such as dipropylene glycol dimethylether, and cyclic ethers such as tetrahydrofurane and 1,4-dioxane. Examples of aromatic hydrocarbons are xylene and solvent naphtha.

A preferred organic solvent is an ester are mixtures thereof. A more preferred organic solvent is an ester of a C₁₋₆-alkanoic acids with a C₁₋₆-alkanol such as butyl acetate and ethyl acetate. A particular preferred organic solvent is butyl acetate.

The solid content of the solution is preferably in the range of 30 to 90% by weight, more preferably 50 to 80% by weight, The viscosity of the solution is preferably in the range of 500 to 15000 mPa×s, more preferably, in the range of 1000 to 10000 mPa×s, most preferably in the range of 2500 to 7000 mPa×s. The viscosity is determined using a cone plate viscosimeter set to a shear rate of 100 s⁻¹ at 23° C.

Also part of the present invention is an organic solvent-based two-component coating composition comprising
a) a first component (K1) comprising (i) the polyester polyol of the present invention, and (ii) optionally at least one polymer carrying more than one OH group, which is different from the polyester polyol of the present invention (D)
   and
b) a second component (K2) comprising (i) at least one compound, oligomer or polymer carrying more than one N═C═O group or blocked N═C═O group (F).

Component D is at least one polymer carrying more than one OH group, which is different from the polyester polyol of the present invention. Preferably, component D is at least one polymer carrying at least two OH groups, which is different from the polyester polyol of the present invention

The polymer carrying more than one OH group can be selected from the group consisting of a (meth)acrylic polymer carrying more than one OH group, a polyester carrying more than one OH group, a polyether carrying more than one OH group, a urea-formaldehyde resin carrying more than one OH group, melamine-formaldehyde resins carrying more than one OH group, a polycarbonate carrying more than one OH group and a polyurethane carrying more than one OH group.

(Meth)acrylic means either methacrylic and/or acrylic.

The (meth)acrylic polymer carrying more than one OH group comprises monomer units derived from at least one (meth)acrylic monomer carrying at least one OH group, from at least one (meth)acrylic monomer carrying no OH groups, and optionally from other ethylenic unsaturated monomers.

Examples of (meth)acrylic monomers carrying at least one OH group are monoesters of (meth)acrylic acid with aliphatic diols, preferably C₁₋₁₀-aliphatic diols, more preferably C₁₋₄ aliphatic diols, such as 2-hydroxyethyl methacrylate, 2-hydroxyethyl acrylate, 2-hydroxypropyl methacrylate, 2-hydroxypropyl acrylate, 3-hydroxypropyl methacrylate, 3-hydroxypropyl acrylate, 4-hydroxybutyl methacrylate, 4-hydroxylbutyl acrylate, 6-hydroxyhexyl methacrylate and 6-hydroxyhexyl acrylate.

Examples of (meth)acrylic monomers carrying no OH group are C₁₋₂₀-alkyl (meth)acrylates such as methyl methacrylate, methyl acrylate, ethyl methacrylate, ethyl acrylate, butyl methacrylate, n-butyl acrylate, n-hexyl methacrylate, n-hexyl acrylate, n-heptyl methacrylate, n-heptyl acrylate, n-octyl methacylate, n-octyl acrylate, 2-ethyl hexyl methacrylate and 2-ethylhexyl acrylate.

Examples of C₁₋₂₀-alkyl are methyl, ethyl, n-propyl, isopropyl, n-butyl, sec-butyl, tert-butyl, n-pentyl, iso-pentyl, sec-pentyl, neopentyl, 1,2-dimethylpropyl, isoamyl, n-hexyl, isohexyl, n-heptyl, isoheptyl, n-octyl, 2-ethylhexyl, trimethylpentyl, n-nonyl, n-decyl, n-undecyl and n-dodecyl.

Further examples of (meth)acrylic monomers carrying no OH group are acrylonitrile, methacrylonitrile, acrylic acid, methacrylic acid, acrylamide, methacrylamide, N-(methoxymethyl)acrylamide, N-(methoxymethyl)methacrylamide, N-(2-methoxyethyl)acrylamide, N-(2-methoxyethyl)methacrylamide, N-(2-methoxypropyl)acrylamide and N-(2-methoxypropyl)methacrylamide.

Examples of other ethylenic unsaturated monomers are unsaturated C₂₋₈-aliphatic compounds such as ethylene, propylene, isobutylene, butadiene and isoprene, C₈₋₂₀-aromatic compounds carrying one vinyl group such as styrene, vinyl toluene, 2-n-butyl styrene, 4-n-butyl styrene and 4-n-decyl styrene, vinyl esters of saturated C₁₋₂₀-fatty acids such as vinyl acetate, vinyl propionate, vinyl stearate and vinyl laurate, alpha, beta-unsaturated carboxylic acids different from methacrylic acid and acrylic acid such as crotonic acid and their C₁₋₂₀-alkyl esters, nitriles and amides, ethylenic unsaturated diacids such as fumaric acid, itaconic acid and maleic acid as well their anhydrides such as maleic anhydride, vinyl ethers of C₁₋₁₀-alcohols such as vinyl methyl ether, vinyl isobutyl ether, vinyl hexyl ether and vinyloctyl ether, vinyl amides such as N-vinyl formamide, N-vinyl pyrrolidone and N-vinylcaprolactam, as well as heteroaromatic compounds carrying one vinyl group such as N-vinyl imidazole.

Preferably, component D is present, and is at least one (meth)acrylic polymer carrying more than one OH group.

Component D is more preferably a (meth)acrylic resin polymer carrying more than one OH group and comprising monomer units derived from at least one (meth)acrylic monomer carrying at least one OH group selected from the group consisting of 2-hydroxyethyl methacrylate, 2-hydroxyethyl acrylate, 2-hydroxypropyl methacrylate, 2-hydroxypropyl acrylate, 3-hydroxypropyl methacrylate, 3-hydroxypropyl acrylate, 4-hydroxybutyl methacrylate and 4-hydroxylbutyl acrylate, from at least one (meth)acrylic monomer carrying no OH groups selected from the group consisting of n-octyl methacylate, n-octyl acrylate, 2-ethyl hexyl methacrylate, 2-ethylhexyl acrylate, acrylonitrile and methacrylonitrile, and from other ethylenic unsaturated monomers selected from the group consisting of C₆₋₂₀-aromatic compounds carrying one vinyl group and vinyl esters of saturated C₁₋₂₀-fatty acids.

Component D is most preferably a (meth)acrylic polymer carrying more than one OH group and comprising monomer units derived from at least one (meth)acrylic monomer carrying at least one OH group selected from the group consisting of 2-hydroxyethyl methacrylate and 2-hydroxyethyl acrylate, and from at least one (meth)acrylic monomer carrying no OH groups selected from the group consisting of 2-ethyl hexyl methacrylate and 2-ethylhexyl acrylate, and from other ethylenic unsaturated monomers selected from the group consisting of C₆₋₂₀-aromatic compounds carrying one vinyl group, which is styrene.

The (meth)acrylic polymer carrying more than one OH group has preferably a number average molecular weight Mn in the range of 500 to 30000 g/mol, more preferably in the range of 500 to 10000 g/mol, even more preferably in the range of 500 to 5000 g/mol. The number average molecular weight is determined using gel permeation chromatography calibrated to a polystyrene standard.

The (meth)acrylic polymer carrying more than one OH group has preferably a weight average molecular weight Mw in the range of 500 to 50000 g/mol, more preferably in the range of 500 to 10000 g/mol, The weight average molecular weight is determined using gel permeation chromatography calibrated to a polystyrene standard.

The (meth)acrylic polymer carrying more than one OH group has preferably a hydroxyl number in the range of 40 to 400 mg KOH/g, more preferably in the range of 50 to 200 mgKOH/g, even more preferably in the range of 80 to 250 mg KOH/g, most preferably in the range of 100 to 180 mg KOH/g. The hydroxyl number is determined according to DIN53240, 2016.

The (meth)acrylic polymer carrying more than one OH group has preferably an acid number of less than 100 mg KOH/g, more preferably of less than 50 mgKOH/g, even more preferably of less than 20 mg KOH/g and most preferably of less than 10 mg KOH/g. The acid number is determined according to DIN53402, 1990.

Component D can be prepared by methods known in the art.

For example, (meth)acrylic polymers carrying more than one OH group comprising monomer units derived from at least one (meth)acrylic monomer carrying at least one OH group, from at least one (meth)acrylic monomer carrying no OH groups, and optionally from other ethylenic unsaturated monomers, can be prepared by radical polymerization of the corresponding monomers. The radical polymerization is usually performed in the presence of at least one radical initiator such as azobis(isobutyronitrile), dibenzoyl peroxide or sodium peroxodisulfate. The radical polymerization can be performed, in organic solution, or in bulk polymerization. The radical polymerization can be performed in a batch process or as continuous process.

The weight ratio of the solid content of all polyester polyols of the present invention to the sum of all polymers carrying more than one OH group, which are different from the polyester polyols of the present invention, (D), and all polyester polyols of the present invention in the first component K1 can be in the range of 1 to 100%, preferably in the range of 10 to 60%, more preferably, in the range of 15 to 40%, most preferably in the range of 20 to 30%.

Component F is at least one compound, oligomer or polymer carrying more than one N═C═O groups or blocked N═C═O groups.

Blocked N═C═O group are groups that can be de-blocked to release the N═C═O group under specific conditions, for example at elevated temperatures, such as at temperatures above 110° C. Compounds, oligomers or polymers carrying more than one blocked N═C═O groups can be prepared, for example, by reacting the corresponding compounds, oligomers or polymers carrying more than one N═C═O group with a compound carrying acidic hydrogens. Examples of compounds carrying acidic hydrogens are diethyl malonate, 3,5-dimethylpyrazole and 2-butanonoxime.

The N═C═O content of the compounds, oligomers or polymers carrying more than one N═C═O group or blocked N═C═O group can be in the range of 1 to 60%, more preferably in the range of 5 to 40%, even more preferably in the range of 15 to 30%, most preferably in the range of 20 to 25%.

The N═C═O content is the weight of all N═C═O groups in X g of compound, oligomer or polymer carrying more than one N═C═O group/X g compound, oligomer or polymer carrying more than one N═C═O group.

When determining the N═C═O content, the compound, oligomer or polymer carrying more than one N═C═O group must be in de-blocked form. The N═C═O content can, for example, be determined by the following method: 10 mL of a 1 N solution of n-dibutyl amine in xylene is added to 1 g of a compound, oligomer or polymer dissolved in 100 mL of N-methylpyrrolidone. The resulting mixture is stirred at room temperature for five minutes. Then, resulting reaction mixture is subjected to back titration using 1 N hydrochloric acid to measure the volume of the hydrochloric acid needed for neutralizing the unreacted n-dibutyl amine. This then reveals how much mol n-dibutyl amine reacted with N═C═O groups. The content of N═C═O is the weight of all N═C═O groups in 1 g of compound, oligomer or polymer carrying more then one N═C═O group/1 g of compound, oligomer or polymer carrying more than one N═C═O group. The weight of all N═C═O groups is “mol reacted n-dibutyl amine” multiplied by the molecular weight of N═C═O, which is 42 g/mol.

The compound carrying more than one N═C═O group or blocked N═C═O group is preferably an aliphatic, alicyclic or aromatic compound carrying at least two N═C═O groups or blocked N═C═O groups, for example an aliphatic, alicyclic or aromatic compound carrying two N═C═O groups or blocked N═C═O groups, or an aliphatic, alicyclic or aromatic compound carrying three N═C═O groups or blocked N═C═O groups.

Aromatic compounds carrying at least two N═C═O groups or blocked N═C═O groups are compounds carrying at least two N═C═O groups or blocked N═C═O groups, wherein at least one N═C═O group is directly attached to an aromatic ring. Alicyclic compounds carrying at least two N═C═O groups or blocked N═C═O groups are compounds carrying at least two N═C═O groups or blocked N═C═O groups, which comprise at least one alicyclic ring and wherein each N═C═O group is not directly attached to an aromatic ring. Aliphatic compound carrying at least two N═C═O groups or blocked N═C═O groups are compounds carrying at least two N═C═O groups or blocked N═C═O groups, which comprise no alicyclic ring, and wherein each N═C═O group is not directly attached to an aromatic ring. Preferred aliphatic, alicyclic and aromatic compounds carrying at least two N═C═O group or blocked N═C═O group, exclusively consist, apart from the N═C═O groups or blocked N═C═O groups, of carbons and hydrogens.

Examples of aliphatic compounds carrying two N═C═O groups are tetramethylene 1,4-diisocyanate, pentamethylene 1,5-diisocyanate, hexamethylene 1,6-diisocyanate, octamethylene 1,8-diisocyanate, decamethylene 1,10-diisocyanate, dodecamethylene 1,12-diisocyanate, tetradecamethylene 1,14-diisocyanate, methyl 2,6-diisocyanatohexanoate, ethyl 2,6-diisocyanatohexanoate, trimethylhexane diisocyanate or tetramethylhexane diisocyanate,

Examples of alicyclic compounds carrying two N═C═O groups are 1,4-diisocyanatocyclohexane, 1,3-diisocyanatocyclohexane, 1,2-diisocyanatocyclohexane, 4,4′-di(isocyanatocyclohexyl)methane, 2,4′-di(isocyanatocyclohexyl)methane, 1-isocyanato-3,3,5-trimethyl-5-(isocyanatomethyl)cyclohexane (isophorone diisocyanate), 1,3-bis(isocyanatomethyl)cyclohexane, 1,4-bis(isocyanatomethyl)cyclohexane, 2,4-diisocyanato-1-methylcyclohexane, 2,6-diisocyanato-1-methylcyclohexane, and 3(or 4),8(or 9)-bis(isocyanatomethyl)tricyclo[5.2.1.0(2,6)]decane.

Examples of aromatic compounds carrying two N═C═O groups are 2,4-tolylene diisocyanate, 2,6-tolylene diisocyanate, m-xylylene diisocyanate, p-xylylene diisocyanate, 2,4′-diisocyanatodiphenylmethane, 4,4′-diisocyanatodiphenylmethane, 1,3-phenylene diisocyanate, 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene and diphenyl ether 4,4′-diisocyanate.

Examples of aliphatic compounds carrying three N═C═O groups are 1,4,8-triisocyanatononane, 2′-isocyanatoethyl 2,6-diisocyanatohexanoate.

Examples of aromatic compounds carrying three N═C═O groups are 2,4,6-triisocyanatotoluene, triphenylmethane triisocyanate and 2,4,4′-triisocyanatodiphenyl ether.

Compounds carrying more than one N═C═O group can be prepared by methods known in the art, for example by treating the corresponding amines with phosgene.

Preferably, component F is at least one an oligomer or polymer carrying more than one N═C═O group or blocked N═C═O group.

The N═C═O content of the oligomer or polymer carrying more than one N═C═O group is preferably in the range of 5 to 40%, even more preferably in the range of 15 to 30%, most preferably in the range of 20 to 25%.

The viscosity of the oligomers or polymers carrying more than one N═C═O group or blocked N═C═O group can be in the range of 10 to 5000 mPas, preferably in the range of 100 to 2000 mPas, more preferably in the range of 500 to 1600 mPas, most preferably in the range of 1000 to 1300 mPas. The viscosity is determined using a cone plate viscosimeter at 23° C. with a shear rate of 100 s⁻¹.

The oligomers or polymers carrying more than one N═C═O group or blocked N═C═O group usually comprise at least one unit independently derived from the group consisting of aliphatic, alicylic and aromatic compounds carrying at least two N═C═O group. Aliphatic, alicylic or aromatic compounds carrying at least two N═C═O groups are as defined above.

Preferably, the oligomers or polymers carrying more than one N═C═O group or blocked N═C═O group are oligomers or polymers carrying more than one N═C═O group or blocked N═C═O groups and comprising (i) at least one unit independently derived from the group consisting of aliphatic, alicylic and aromatic compounds carrying at least two N═C═O groups, and (ii) at least one structural unit selected from the group consisting of uretdione, isocyanurate, biuret, urea, carbodiimide, uretonimine, urethane, allophanate, oxadiazinetrione and iminooxadiazinedione.

Oligomers or polymers carrying more than one N═C═O group and comprising (i) at least one unit independently derived from the group consisting of aliphatic, alicylic and aromatic compounds carrying two N═C═O groups and (ii) at least one uretdione unit can, for example, be obtained by oligomerisation or polymerization of at least one aliphatic, alicyclic or aromatic compound carrying at least two, preferably two, N═C═O groups. Oligomers comprising at least one uretdione unit and two units derived from an aliphatic, alicylic or aromatic compounds carrying at least two N═C═O groups are so-called “uretdione dimers”.

Oligomers or polymers carrying more than one N═C═O group and comprising (i) at least one unit independently derived from the group consisting of aliphatic, alicylic and aromatic compounds carrying at least two N═C═O group and (ii) at least one isocyanurate unit can, for example, be obtained by oligomerisation or polymerization of at least one aliphatic, alicyclic or aromatic compound carrying at least two, preferably two, N═C═O groups. Oligomers comprising at least one isocyanurate unit and three units derived from aliphatic, alicylic or aromatic compounds carrying at least two N═C═O groups are so-called “isocyanurate trimers”.

The oligomerization or polymerization of aliphatic, alicylic and aromatic compounds carrying at least two N═C═O group can be performed by methods known in the art. For example, the oligomerization of aliphatic, alicyclic or aromatic compounds carrying two N═C═O groups can be performed in the presence of a suitable catalyst such as tetra-substituted ammonium or tetra-substituted phosphonium compounds having hydroxide, carboxylates, carbonates or hydrogen-difluoride as counterions. When the oligomerization is performed in the presence of a catalyst, the oligomerization must be stopped after a target N═C═O content has been reached in order to avoid an uncontrolled increase in molar mass and viscosity. For this purpose, the catalyst used is deactivated in an appropriate way, for example by thermal deactivation, extraction with a suitable solvent, binding to an absorbent or by addition of a catalyst poison which reduces the activity of the catalyst. Unreacted aliphatic, alicyclic or aromatic compound carrying two N═C═O groups can be removed by distillation.

Oligomers or polymers carrying more than one N═C═O group and comprising (i) at least one unit independently derived from the group consisting of aliphatic, alicylic and aromatic compounds carrying at least two N═C═O groups and (ii) at least one biuret unit can, for example, be obtained by oligomerisating or polymerization an aliphatic, alicyclic or aromatic compound carrying at least two N═C═O groups with urea.

Oligomers or polymers carrying more than one N═C═O group and comprising (i) at least one unit independently derived from the group consisting of aliphatic, alicylic and aromatic compounds carrying at least two N═C═O groups and (ii) at least one urea unit can, for example, be obtained by oligomerisating or polymerization an aliphatic, alicyclic or aromatic compound carrying at least two N═C═O groups with a diamine or polyamine.

Oligomers or polymers carrying more than one N═C═O group and comprising (i) at least one unit independently derived from the group consisting of aliphatic, alicylic and aromatic compounds carrying at least two N═C═O groups and (ii) at least one carbodiimide unit can, for example, be obtained from the oligomers or polymers carrying at least two N═C═O groups and comprising (i) at least one unit independently derived from the group consisting of aliphatic, alicylic and aromatic compounds carrying at least two N═C═O groups and (ii) at least one urea unit.

Oligomers or polymers carrying more than one N═C═O group and comprising (i) at least one unit independently derived from the group consisting of aliphatic, alicylic and aromatic compounds carrying at least two N═C═O groups and (ii) at least one uretonimine unit can, for example, be obtained by reacting an aliphatic, alicyclic or aromatic compound carrying at least two N═C═O groups with oligomers or polymers carrying at least two N═C═O group and comprising (i) at least one unit independently derived from the group consisting of aliphatic, alicylic and aromatic compounds carrying at least two N═C═O groups and (ii) at least one carbodiimide unit.

Oligomers or polymers carrying more than N═C═O group and comprising (i) at least one unit independently derived from the group consisting of aliphatic, alicylic and aromatic compounds carrying at least two N═C═O groups and (ii) at least one urethane unit can, for example, be obtained by oligomerisating or polymerizating an aliphatic, alicyclic or aromatic compound carrying at least two N═C═O groups with a diol or polyol.

Oligomers or polymers carrying more than one N═C═O group and comprising (i) at least one unit independently derived from the group consisting of aliphatic, alicylic and aromatic compounds carrying at least two N═C═O groups and (ii) at least one allophanate unit can, for example, be obtained by reacting an aliphatic, alicyclic or aromatic compound carrying at least two N═C═O groups with oligomers or polymers carrying at least two N═C═O group and comprising (i) at least one unit independently derived from the group consisting of aliphatic, alicylic and aromatic compounds carrying at least two N═C═O groups and (ii) at least one urethane unit.

Examples of oligomers or polymers carrying more than one N═C═O groups are also so-called “polymeric diphenyldiisocyanate”.

More preferably, component F is at least one oligomer or polymer carrying more than one N═C═O group or blocked N═C═O group and comprising (i) at least one unit independently derived from the group consisting of aliphatic and alicylic compounds carrying at least two N═C═O groups, and (ii) at least one structural unit selected from the group consisting of uretdione, isocyanurate, biuret, urea, carbodiimide, uretonimine, urethane, allophanate, oxadiazinetrione and iminooxadiazinedione.

Even more preferably, component F is at least one oligomer or polymer carrying more than one N═C═O group and comprising (i) at least one unit independently derived from the group consisting of aliphatic and alicylic compounds carrying at least two N═C═O groups, and (ii) at least one isocyanurate structural unit.

Most preferably, component F is at least one oligomer or polymer carrying more than one N═C═O group and comprising (i) at least one unit independently derived from the group consisting of hexamethylene-1,6-diisocyanate, 4,4′-di(isocyanatocyclohexyl)methane, 2,4′-di(isocyanatocyclohexyl)methane and 1-isocyanato-3,3,5-trimethyl-5-(isocyanatomethyl)cyclohexane (isophorone diisocyanate), and (ii) at least one isocyanurate structural unit.

In particular, component F is at least one oligomer or polymer carrying more than one N═C═O group and comprising (i) at least one unit derived from hexamethylene-1,6-diisocyanate and (ii) at least one isocyanurate structural unit.

The compounds, oligomers or polymers carrying more than one N═C═O groups are usually used in an amount that the mol N═C═O groups derived from all compounds, oligomers and polymers carrying more than one N═C═O group to the sum of mol OH groups derived from the polyester polyols of the present invention and component D is from 80 to 120%, preferably from 90 to 110%. A ratio of 100% is also referred to as so-called “Index 100”.

The organic solvent-based two-component coating composition comprises at least one organic solvent.

Suitable organic solvents are esters, ketones, amides, ethers and aromatic hydrocarbons and mixtures thereof.

Examples of esters of are ethyl acetate, butyl acetate, 1-methoxy-2-propyl acetate, 2-butoxy ethyl acetate (butyl gycol acetate), propylene glycol diacetate, ethyl 3-ethoxypropionate, 3-methoxybutyl acetate, butyldiglycol acetate and propylene carbonate. Examples of ketones are acetone, methyl ethyl ketone and methyl isobutyl ketone. Examples of amides are dimethylformamide (DMF) and N-methyl pyrrolidone (NMP). Example of ethers are glycol ethers such as dipropylene glycol dimethylether, and cyclic ethers such as tetrahydrofurane and 1,4-dioxane. Examples of aromatic hydrocarbons are xylene and Solvesso 100.

A preferred organic solvent is an ester are mixtures thereof. A more preferred organic solvent is an ester of a C₁₋₆-alkanoic acids with a C₁₋₆-alkanol such as butyl acetate and ethyl acetate. A particular preferred organic solvent is butyl acetate.

The organic solvent-based two-component coating composition, preferably, also comprises at least one catalyst.

Examples of catalysts are organic bases, organic acids, organic metal compounds and inorganic metal salts.

Examples organic bases are amines such as diazobicyclo[2.2.2]octane (DABCO), amidine or guanidine-type compounds such as 1,5,7-triazabicyclo[4.4.0]dec-5-ene (TBD), N-methyl-1,5,7-triazabicyclododecene (MTBD), 1,8-diazabicyclo[5.4.0]undec-7-ene (DBU) and N-hetercyclic carbenes such as 1,3-bis(ditert-butyl)imidazole-2-ylidene.

Examples of organic acids are organic sulfonic acids such as methylsulfonic acid and trifluoromethylsulfonic acid, and phosphonic acids such as diphenylphosphonic acid.

Examples of organic metal compounds are organic antimony compounds, organic bismuth compound, organic germanium compounds, tin compounds, organic lead compounds, organic aluminium compounds, organic zinc compounds, organic mercury compounds, organic copper compounds, organic nickel compounds, organic cobalt compounds, organic manganese compounds, organic molybdenum compounds, organic vanadium compounds, organic titanium compounds, organic zirconium compounds and organic cesium compounds.

Examples of organo tin compounds are organo tin(II) compounds such as tin(II) diacetate, tin(II) dioctoate, tin(II) bis(2-ethylhexanoate) and tin(II) dilaurate, as well as dialkyltin(IV) compounds such as dimethyltin(IV) diacetate, dibutyltin(IV) diacetate, dibutyltin(IV) dibutyrate, dibutyltin(IV) bis(2-ethylhexanoate), dibutyltin(IV) dilaurate, dibutyltin(IV) maleate, dioctyltin(IV) dilaurate and dioctyltin(IV) diacetate.

Examples of an organo zinc compounds are zinc(II) dioctoate and zinc(II) acetylacetonate. An example of an organo bismuth compound is bismuth(III) tris(neodecanoate).

Examples of organo zirconium compounds are zirconium(IV) tetrakis(acetylacetonate), zirconium (IV) tetrakis(2,4-pentandionate) and zirconium(IV) terakis(2,2,6,6-tetramethyl-3,5-heptanedionate).

An example of an organo iron compound is iron(III) tris(acetylacetonate). An example of an organo titanium compound is titanium(IV) tetrakis(acetylacetonate). An example of an organo manganese compound is manganese(III) tris(acetylacetonate). An example of an organo nickel compound is nickel(II) bis(acetylacetonate). Examples of an organo cobalt compounds are cobalt(II) bis(acetylacetonate) and cobalt (III) tris(acetylacetonate). Examples of organic molybdenum compounds are molybdenum(II) bis(acetylacetonate) and molybdenum dioxide tetramethylheptadionate. Examples of an organic cesium compound is cesium propionate and cesium 2-ethylhexanoate.

Examples of inorganic metal salts are lithium molybdate, lithium tungsstate and cesium phosphate.

Preferably the catalyst is an organic metal compound. More preferably, the catalyst is an organic metal compound selected from the group consisting of organic tin compounds, organic zinc compounds and organic zirconium compounds. Even more preferably, the catalyst is selected from the group consisting of dimethyltin(IV) diacetate, dibutyltin(IV) dibutyrate, dibutyltin(IV) bis(2-ethylhexanoate), dibutyltin(IV) dilaurate, dioctyltin(IV) dilaurate, zinc(II) dioctoate, zirconium(IV) tetrakis(acetylacetonate) and zirconium(IV) tetrakis(2,2,6,6-tetramethyl-3,5-heptanedionate). Most preferably, the catalyst is dibutyltin(IV) dilaurate.

The amount catalyst can be chosen so that the flow time of the composition according to DIN EN 53211, 1987 using a flow cup having a 4 mm hole diameter doubles after 2 hours standing at room temperature with respect to the flow time of the composition directly after mixing component K1 and component K2.

The catalyst is usually used in an amount in the range of 50 to 10000 ppm, preferably 50 to 5000 ppm, more preferably 90 to 2000 ppm, based on the weight of all OH-group carrying components of the composition of the present invention.

The organic-solvent-based two component coating composition can comprise further additives such as light stabilizers, antistatic agents, flame retardants, thickeners, thixotropic agents, surface-active agents, viscosity modifiers, plasticizers, chelating agents, pigment, dyes and fillers.

Examples of light stabilizers are UV absorbers and hindered amine light stabilizers (HALS).

Examples of UV absorbers are benzotriazoles such as benzenepropanoic acid, 3-(2H-benzotriazol-2-yl)-5-(1,1-dimethylethyl)-4-hydroxy ester and α-[3-[3-(2H-benzotriazol-2-yl) (1,1-dimethylethyl)-4-hydroxyphenyl]-1-oxopropyl]-w-hydroxypoly(oxo-1,2-ethanediyl), as well as benzophenones such as 2-hydroxy-4-n-octoxy benzophenone.

Examples hindered amine light stabilizers are 2,2,6,6-tetramethylpiperidine, 2,6-di-tert-butylpiperidine, bis(2,2,6,6-tetramethyl-4-piperidyl) sebacate, bis(1,2,2,6,6-pentamethyl piperidinyl) [[3,5-bis(1,1-dimethylethyl)-4-hydroxyphenyl]methyl]butylmalonate, bis(1,2,2,6,6-pentamethyl-4-piperidinyl) sebacate, methyl(1,2,2,6,6-pentamethyl-4-piperidinyl) sebacate and decanedioic acid, bis(1-octyloxy-2,2,6,6-tetramethyl-4-piperidinyl) ester.

Examples of thickeners are hydroxymethylcellulose and bentonite.

An example of a chelating agent is ethylenediaminetetraacetic acid.

Pigments can be organic or an organic absorption pigments or organic or an organic effect pigments.

Examples of organic absorption pigments are azo pigments, phthalocyanine pigments, quinacridone pigments, and pyrrolopyrrole pigments. Examples of inorganic absorption pigments are iron oxide pigments, titanium dioxide and carbon black.

Effect pigments are all pigments which exhibit a platelet-shaped construction and give a surface coating specific decorative color effect. The effect pigments can be pure metallic effect pigments such as aluminum, iron or copper effect pigments, interference effect pigments such as titanium dioxide-coated mica effect pigments, iron oxide-coated mica effect pigments, mixed oxide-coated mica effect pigments and metal oxide-coated aluminum effect pigments, or liquid-crystal effect pigments.

Examples of dyes are azo, azine, anthraquinone, acridine, cyanine, oxazine, polymethine, thiazine and triarylmethane dyes.

Examples of fillers are silica gel, kieselguhr, talc, calcium carbonate, kaolin, barium sulfate, magnesium silicate, aluminum silicate, siliceous earth, crystalline silicon dioxide, amorphous silica, aluminum oxide, microspheres or hollow microspheres made, for example, of glass, ceramic or polymers, urea-formaldehyde condensates, micronized polyolefin wax and micronized amide wax. Preferred fillers are siliceous earth, talc, aluminum silicate, magnesium silicate and calcium carbonate.

Preferably, at least 30 weight %, more preferably at least 50 weight %, even more preferably at least 80 weight %, most preferably at least 90 weight % of the solid content of the organic solvent-based two-component coating composition is derived from the sum of polyester polyol of the present invention, all polymers carrying more than one OH group, which are different from the polyester polyol of the present invention (D), and all compounds, oligomers or polymers carrying more than one N═C═O group or blocked N═C═O group (F).

Preferably, the organic solvent-based two-component coating composition consists of
a) a first component (K1) consisting of (i) the polyester polyol of the present invention, and (ii) optionally at least one polymer carrying more than one OH group, which is different from the polyester polyol of the present invention (D),
b) a second component (K2) consisting of (i) at least one compound, oligomer or polymer carrying more than one N═C═O group or blocked N═C═O group (F),
c) at least one organic solvent
d) optionally at least one catalyst, and
e) optionally additives.

The organic solvent-based two-component coating composition can be prepared by mixing the first component (K1) with the second component (K2) in the presence of at least one organic solvent. At least one catalyst or further additives can be present when mixing the first component (K1) with the second component (K2), or added after when mixing the first component (K1) with the second component (K2).

The flow time of the solvent-based two-component coating composition can be adjusted by addition of at least one organic solvent. This organic solvent can be the organic solvent already used as organic solvent in the first component K1. The flow time can be, for example adjusted so that the flow time is in the range of 10 to 30 seconds, preferably in the range of 15 to 25 seconds according to DIN EN 53211, 1987 using a flow cup having a 4 mm hole diameter

Also part of the present invention is a substrate coated with the composition of the present invention.

Examples of substrates are wood, wood veneer, paper, cardboard, paperboard, textile, film, leather, nonwoven, plastics surfaces, glass, ceramic, mineral building materials, such as molded cement blocks and fiber-cement slabs, and metals, which in each case are optionally precoated or pretreated. A preferred substrate is metal, which is optionally precoated or pretreated.

The composition of the present invention can be applied to the substrate by methods common in the art such as by draw down bar, spraying, troweling, knifecoating, brushing, rolling, rollercoating, flowcoating and laminating.

Following the application of the composition of the invention, the composition of the present invention is cured at a temperature in the range of 20 to 140° C., preferably in the range of 20 to 100° C.

The thickness of the “wet” layer formed from the composition of the present invention is usually in the range of 20 to 5000 μm, preferably in the range of 50 to 500 μm, more preferably in the range of 100 to 250 μm. After curing, the thickness of the layer is usually in the range of 10 to 500 μm, preferably in the range of 15 to 200 μm, more preferably in the range of 20 to 100 μm.

Substrates coated with the composition of the present invention can, for example, be part of automotives, large vehicles, aircrafts, utility vehicles in agriculture and construction, bridges, buildings, power masts, tanks, containers, pipelines, power stations, chemical plants, ships, cranes, posts, sheet piling, valves, pipes, fittings, flanges, couplings, halls, roofs, furniture, windows, doors, woodblock flooring, cans, coils and floors.

The composition of the present invention can, for example, be used as clearcoat, basecoat and topcoat, primer and surfacer.

Also part of the present invention is the use of the composition of the present invention in automotive refinish applications.

The organic solvent-based two-component coating compositions of the present invention have a high solid content and thus a low amount of organic solvent. In addition, the organic solvent-based two-component coating compositions of the present invention have a long gel time.

The organic-solvent based two-component polyurethane coating compositions of the present invention once applied to the substrate usually are fast-drying, and the coatings formed from the organic solvent-based two-component coating composition show good mechanical properties such as a high pendulum hardness.

### EXAMPLES

### Description of Test Methods

The weight average molecular weight Mw and number average molecular weight Mn were determined using gel permeation chromatography calibrated to a polystyrene standard.

The glass transition temperature (Tg) was determined using differential scanning calorimetry.

The hydroxyl number was determined according to DIN53240, 2016.

The acid number was determined according to DIN53402, 1990.

The solid content of solutions comprising polyester polyol were measured using a moisture analyzer (Mettler Toledo HB43-S Moisture Analyzer) at 160° C. until constant mass was reached. The solid content of two-component compositions comprising the polyester polyol solutions were calculated based on the measured solid content of the polyester polyol solutions.

The viscosity was determined using a cone plate viscosimeter set to a shear rate of 100 s⁻¹ at 23° C.

Gel time: The coating composition was filled in the test tube until at least 60% filling height was reached. The test tube was covered and placed into a free slot of the gel timer. The metal spoked wheel was fixed with its bent end facing downwards in the spoked wheel holder, using the length indication on top of the gel timer. The spoked wheel holder was placed on the gel timer, so that the metal spoked wheel dipped into the coating composition. The device was switched on. The mixture of each slot was stirred up and down by the metal spoked wheel until gelling occurred. When gelling occurred, the whole test tube is lifted by the up-moving stirrer and the contact between the bottom side of the test tube and the device is broken which is noted by the apparatus. The gel timer showed the time until gelling in hours and minutes following the decimal system.

Cotton wool drying time: The coating composition was applied with a draw down bar on a glass plat yielding a wet film thickness of 150 μm. After film application, a frayed cotton wool was swept without pressure across the surface of the coating every 5 to 10 minutes. At the beginning, cotton fibers were sticking to the coating. The time when no fibers remained attached to the coating, is referred to as the cotton wool drying time.

Sand drying time: The coating composition was applied with a draw down bar on two glass plates yielding a wet film thickness of 150 μm. The glass plates with the wet film were quickly placed under a cylindrical funnel that moves at constant velocity of 1 cm per hour over the wet film. Along the way, sand trickles out of the funnel on the film. When the film is not surface-cured, the film is still tacky and the sand sticks to it. When the film is surface-cured, the sand can be wiped away with a brush. The length (1 cm length refers to 1 hour) of the sand path sticking to the coating is referred to as sand drying time.

Sand through drying time: The coating composition was applied with a draw down bar on two glass plates yielding a wet film thickness of 150 μm. A cylindrical funnel mounted on two small metal wheels, one on each side of the funnel outlet, was quickly placed on the glass plates with the wet film. The the cyclindrical funnel on wheels moves at constant velocity of 1 cm per hour over the wet film. When the film is not “through-cured”, the wheels leave marks on the film. When the film is “through-cured”, the wheels leave no marks on the film anymore. The length (1 cm length refers to 1 hour) of the marks of the wheels in the coating is referred to as sand through drying time.

Pendulum hardness [osc.]: The coating composition was applied with a draw down bar having a gap of 150 μm on a 4 mm thick glass plate, which has been cleaned with acetone before, yielding a wet film. The coated glass plates were dried at 23° C., and the pendulum hardness was measured after 1, 2, 3 and 7 days. After 7 days, the glass plass plates were additionally heated to 60° C. for 15 hours, and after cooling to 23° C., the pendulum hardness was measured again. The pendulum hardness was measured according to DIN EN ISO 1522:2006 using the König pendulum.

### Example 1

### Preparation of Polyester Polyols 1a, 1b, 1c and 1d, and Comparative Polyester Polyol Comp1a

### Preparation of Polyester Polyol 1a

Cyclohexane-1,2-dicarboxylic acid anhydride (mixture of isomers) (HHPA) (556.0 g, 3.606 mol, 2 equivalents), 1,4-bis(hydroxymethyl)-cyclohexane (CHDM) (195.1 g, 1.353 mol, 0.75 mol equivalents), 1,3,5-tris(2-hydroxyethyl) isocyanurate (THEIC) (176.7 g, 0.674 mol, 0.375 mol equivalents), 1,1,1-trimethylolpropane (TMP) (272.2 g, 2.028 mol, 1.125 mol equivalents) were added into a 4 L round bottom flask equipped with a mechanical stirrer, digital thermometer, distilling trap, reflux cooler and nitrogen-inlet. The reaction was carried out under a steady flow of nitrogen. The reaction mixture was slowly heated to 160° C. When the reaction mixture reached 135° C., an exothermic reaction was observed. The reaction mixture was kept at 160° C. for 30 min, and then heated to 180° C. The reaction was monitored by the titration of hydroxyl number and acid number until the acid number reached a value of 7.7 mg KOH/g. The melt was cooled to 80° C. and butyl acetate was added until a solid content of 68.1% was reached. The hydroxyl number, the acid number, the molecular weight and the Tg of polyester polyol 1a, as well as the solid content and the viscosity of the solution of polyester polyol 1a in butyl acetate were determined according to the methods described in the section above titled “Description of test methods” and is shown in table 1.

Preparation of polyester polyols 1b, 1c and 1d and comparative polyester polyol comp1a Polyester polyols 1b, 1c, 1d and comparative polyester polyol comp1a were prepared in analogy to polyester polyol 1a but using the molar monomer ratios shown in table 1 and keeping the reaction mixture at 180° C. until the hydroxyl number as indicated in table 1 is reached. Butyl acetate was added until the solid content as indicated in table 2 was reached. The hydroxyl numbers, the acid numbers, the molecular weights and the Tgs of polyester polyols 1b, 1c, 1d and comp1a, as well as the solid contents and the viscosities of the solutions of polyester polyols 1b, 1c, 1d and comp1a in butyl acetate were determined according to the methods described in the section above titled “Description of test methods” and are shown in table 1.

TABLE 1

| | polyester polyol | | | | |
|---|---|---|---|---|---|
| | comp1a | 1a | 1b | 1c | 1d |
| monomers | | | | | |
| HHPA | 2 | 2 | 2 | 2 | 2 |
| CHDM | 0.75 | 0.75 | 0.75 | 0.75 | 0.75 |
| THEIC | 0 | 0.375 | 0.75 | 1.125 | 1.5 |
| TMP | 1.5 | 1.125 | 0.75 | 0.375 | 0 |
| properties | | | | | |
| Hydroxyl number | 183.2 | 172.8 | 171.8 | 169.0 | 171.1 |
| [mg KOH/g] | | | | | |
| acid number | 3.3 | 7.7 | 16.3 | 24.9 | 39.9 |
| [mg KOH/g] | | | | | |
| Mn [g/mol] | 2921 | 2096 | 1438 | 1146 | 873 |
| Mw [g/mol] | 18039 | 9218 | 4088 | 2586 | 1537 |
| Tg [° C.] | 40.4 | 47 | 46.4 | 43.8 | 45.6 |
| solid content [%] | 68.1 | 68.1 | 68.2 | 68.1 | 68.0 |
| viscosity | 5980 | 4459 | 3808 | 3033 | 4081 |
| [mPa × s] | | | | | |

### Example 2

Preparation and application of “clear coat” coating compositions comprising the polyester polyols 1a, 1b, 1c and 1d and comparative polyester polyol comp1a, respectively, of example 1

4.8 g of a 1 wt % solution of dibutyltin dilaurate in butylacetate was added in a 250 mL glass jar. Afterwards 45 g Joncryl® 507 (80 wt % solution of a hydroxyl-functional acrylic polymer in butyl acetate) was combined with 17.6 g of a 68 wt % solution of the polyester polyols 1a, 1b, 1c, 1d and comparative polyester polyol comp1a, respectively, of example 1 in butyl acetate and added to the dibutyltin dilaurate solution. The mixture was stored for 16 h. Basonat® HI 2000 NG (solvent-free, aliphatic polyisocyanate) at an index of 100 was added to the mixture, followed by addition of butyl acetate to adjust the solid content to approximately 63 wt %. After stirring the mixture for 10 to 15 min at 750 rpm with a lab stirrer using a 40 mm disc the flow time was measured. Subsequently, butyl acetate was added in an amount that the flow time according to DIN EN 53211:1987 using a flow cup having a 4 mm hole diameter corresponds to 20 sec. After waiting for 10 min, the “clear coat” coating composition was ready to use. After cleaning the substrates properly with acetone (glass plates) the “clear coat” coating compositions were applied with a draw down bar with a wet film thickness of 150 μm. The dry film thickness was approximately 45 μm.

The solid content, the gel time, the cotton wool drying time, the sand drying time, the sand through drying time and the pendulum hardness [osc.] of the “clear coat” coating compositions comprising polyester polyols 1b, 1c, 1d and comp1a were determined as described above in the section titled “Description of Test Methods” and are shown in table 2.

TABLE 2

| | “clear coat” coating compositions comprising | | | | |
|---|---|---|---|---|---|
| | polyester polyols | | | | |
| | Comp1a | 1a | 1b | 1c | 1d |
| monomers | | | | | |
| HHPA | 2 | 2 | 2 | 2 | 2 |
| CHDM | 0.75 | 0.75 | 0.75 | 0.75 | 0.75 |
| THEIC | 0 | 0.375 | 0.75 | 1.125 | 1.5 |
| TMP | 1.5 | 1.125 | 0.75 | 0.375 | 0 |
| properties | | | | | |
| solid content [%] | 58.3 | 59.2 | 59.7 | 60.1 | 60.1 |
| gel time | 7 h | 11 h | 18 h | 19 h | 19 h |
| | 50 min | 42 min | 34 min | 32 min | 09 min |
| cotton wool drying | >720 | >720 | 580 | >540 | 450 |
| time [min] | | | | | |
| sand drying time | 19.5 | 19.5 | 18.5 | 14.5 | 11 |
| [h] | | | | | |
| sand through drying | 24 | 24 | 24 | 24 | 19 |
| time [h] | | | | | |
| pendulum hardness | 9 | 9 | 12 | 19 | 27 |
| [osc.] after 1 d | | | | | |
| pendulum hardness | 44 | 50 | 59 | 70 | 81 |
| [osc.] after 2 d | | | | | |
| pendulum hardness | 73 | 80 | 91 | 100 | 106 |
| [osc.] after 3 d | | | | | |
| pendulum hardness | 126 | 130 | 131 | 130 | 129 |
| [osc.] after 7 d | | | | | |
| pendulum hardness | 133 | 133 | 132 | 128 | 127 |
| [osc.] after | | | | | |
| 7 d + 15 h | | | | | |
| (the last 15 h | | | | | |
| at 60° C.) | | | | | |

Table 2 shows that the replacement of 1,1,1-trimethylolpropane (TMP) with 1,3,5-tris(2-hydroxyethyl) isocyanurate (THEIC) leads to “clear coat” coating compositions of higher solid content and longer gel time. With increasing amount of TMP, the “clear coat” coating compositions also show a shorter cotton wool drying time and a shorter sand drying time, and an increased pendulum hardness [osc.] after 1, 2, 3 and 7 days.

### Example 3

### Preparation of Comparative Polyester Polyols Comp1b, Comp1c, Comp1d and Comp1e

Comparative polyester polyol comp1b, comp1c, comp1d and comp1e were prepared in analogy to polyester polyol 1a but using the monomer ratios shown in table 3 and keeping the reaction mixture at 180° C. until the acid number indicated in table 3 is reached. Butyl acetate was added until the solid content as indicated in table 3 is reached. The hydroxyl numbers, the acid numbers, the molecular weights and the Tgs of comparative polyester polyols comp1b, comp1c, comp1d and comp1e, as well as the solid contents and the viscosities of the solutions of polyester polyols 1b, 1c, comparative polyester polyols comp1b, comp1c, comp1d and comp1e in butyl acetate were determined according to the methods described in the section above titled “Description of test methods” and are shown in table 3.

TABLE 3

| | Polyester Polyol | | | |
|---|---|---|---|---|
| | comp1b | comp1c | comp1d | comp1e |
| Monomer | | | | |
| HHPA | 2 | 2 | 2 | 2 |
| CHDM | 0 | 0 | 0 | 0 |
| THEIC | 0 | 0.393 | 0.785 | 1.178 |
| TMP | 1.571 | 1.178 | 0.785 | 0.393 |
| Property | | | | |
| hydroxyl number | 156 | 172 | 174 | 151 |
| [mg KOH/g] | | | | |
| acid number | 88 | 115 | 119 | 104 |
| [mg KOH/g] | | | | |
| Mn [g/mol] | 1924 | 1015 | 821 | 823 |
| Mw [g/mol] | 6146 | 1571 | 1183 | 1251 |
| Tg [° C.] | 21.4 | 22.2 | 23.3 | 23.0 |
| solid content [%] | 66.0 | 67.4 | 67.3 | 67.2 |
| viscosity | 4177 | 1921 | 2752 | 4751 |
| [mPa × s] | | | | |

### Example 4

### Preparation and Application of “Clear Coat” Coating Compositions Comprising the Comparative Polyester Polyols Comp1b, Comp1c, Comp1d and Comp1e of Example 3

4.8 g of a 1 wt % solution of dibutyltin dilaurate in butylacetate was added in a 250 mL glass jar. Afterwards 45 g of Joncryl® 507 (80 wt % solution of a hydroxyl-functional acrylic polymer in butyl acetate) was combined with 18.18 g of a 66 wt % solution of the polyester polyols comp1b, comp1c, comp1d and comp1e of example 3 in butyl acetate and added to the dibutyltin dilaurate solution. The mixture was stored for 16 h. Basonat® HI 2000 NG (solvent-free, aliphatic polyisocyanate) at an index of 100 was added to the mixture, followed by addition of butyl acetate to adjust the solid content to approximately 63 wt %. After stirring the mixture for 10 to 15 min at 750 rpm with a lab stirrer using a 40 mm disc the flow time was measured. Subsequently, butyl acetate was added in an amount that the flow time according to DIN EN 53211:1987 using a flow cup having a 4 mm hole diameter corresponds to 20 sec. After waiting for 10 min, the “clear coat” coating composition was ready to use. After cleaning the substrates properly with acetone (glass plates) the “clear coat” coating compositions were applied with a draw down bar with a wet film thickness of 150 μm. The dry film thickness was approximately 45 μm.

The solid content, the gel time, the cotton wool drying time, the sand drying time, the sand through drying time and the pendulum hardness [osc.] of the “clear coat” coating compositions comprising polyester polyols comp1b, comp1c, comp1d and comp1e were determined as described above in the section titled “Description of Test Methods” and are shown in table 4.

TABLE 4

| | “clear coat” coating compositions comprising | | | |
|---|---|---|---|---|
| | polyester polyols | | | |
| | comp1b | comp1c | comp1d | comp1e |
| monomers | | | | |
| HHPA | 2 | 2 | 2 | 2 |
| CHDM | 0 | 0 | 0 | 0 |
| THEIC | 0 | 0.393 | 0.785 | 1.178 |
| TMP | 1.571 | 1.178 | 0.785 | 0.393 |
| properties | | | | |
| Tg [° C.] | 21.4 | 22.2 | 23.3 | 23.0 |
| solid content [%] | 56.8 | 56.7 | 57.7 | 57.8 |
| gel time | 15 h | 13 h | 13 h | 14 h |
| | 54 min | 12 min | 53 min | 47 min |
| cotton wool drying | 200 | 100 | 130 | 100 |
| time [min] | | | | |
| sand drying time [h] | 7 | 5 | 6 | 6 |
| sand through drying | 12 | 9 | 11 | 11 |
| time [h] | | | | |
| pendulum hardness | 56 | 62 | 62 | 54 |
| [osc.] after 1 d | | | | |
| pendulum hardness | 110 | 90 | 100 | 97 |
| [osc.] after 2 d | | | | |
| pendulum hardness | 123 | 98 | 110 | 112 |
| [osc.] after 3 d | | | | |
| pendulum hardness | 123 | 100 | 115 | 119 |
| [osc.] after 7 d | | | | |
| pendulum hardness | 111 | 109 | 118 | 118 |
| [osc.] after 7 d plus | | | | |
| 15 h at 60° C. | | | | |

Table 4 shows that the replacement of 1,1,1-trimethylolpropane (TMP) with 1,3,5-tris(2-hydroxyethyl) isocyanurate (THEIC) does not lead to “clear coat” coating compositions of high solid content when 1,4-bis(hydroxymethyl)-cyclohexane (CHDM) is not present in the composition. In addition, the replacement of 1,1,1-trimethylolpropane (TMP) with 1,3,5-tris(2-hydroxyethyl) isocyanurate (THEIC) does not lead to “clear coat” coating compositions of longer gel time when 1,4-bis(hydroxymethyl)-cyclohexane (CHDM) is not present in the composition.

When comparing the properties of “clear coat” coating compositions comprising polyester polyols comp1c, comp1d and comp1e shown in table 4 with the properties of “clear coat” coating compositions comprising polyester polyols 1a, 1b and 1c shown in table 2, it can be seen that “clear coat” coating compositions comprising 1,4-bis(hydroxymethyl)cyclohexane (CHDM) are of higher solid content and higher pendulum hardness [osc.] after 7 days as well as after 7 days plus 15 h at 60° C. compared to “clear coat” compositions not comprising CHDM. With increasing amount of TMP, “clear coat” coating compositions comprising 1,4-bis(hydroxymethyl)cyclohexane (CHDM) are also of longer gel time compared to “clear coat” compositions not comprising CHDM.

1.-16. (canceled)

17. A polyester polyol comprising units derived from
a) at least one COOH group or derivative thereof carrying component or mixture of components (A) comprising at least one compound carrying two COOH groups or derivatives thereof (A1),
b) at least one OH group carrying component or mixture of components (B) comprising
(i) at least one compound carrying three OH groups selected from the group consisting of 1,3,5-tris(hydroxymethyl)isocyanurate, 1,3,5-tris(2-hydroxyethyl) isocyanurate, 1,3,5-tris(2-hydroxyisopropyl)isocyanurate, 1,3,5-tris(2-hydroxypropyl)isocyanurate and 1,3,5-tris(2-hydroxybutyl)isocyanurate (B1),
(ii) at least one compound carrying two OH groups selected from the group consisting of 1,1-bis(hydroxymethyl)-cyclohexane, 1,2-bis(hydroxymethyl)cyclohexane, 1,3-bis(hydroxymethyl)-cyclohexane, 1,4-bis(hydroxymethyl)cyclohexane, 1,1-bis(hydroxyethyl)-cyclohexane, 1,2-bis(hydroxyethyl)cyclohexane, 1,3-bis(hydroxyethyl)-cyclohexane and 1,4-bis(hydroxyethyl)cyclohexane (B2),
(iii) optionally at least one compound or polymer carrying at least three OH groups, which is different from B1 (B3), and
(iv) optionally at least one compound or polymer carrying two OH groups, which is different from B2 (B4),
and
c) optionally at least one compound carrying at least one OH group and at least one COOH group or a derivative thereof (C).

18. The polyester polyol of claim 17 obtained by a process comprising the step of reacting
a) at least one COOH group or derivative thereof carrying component or mixture of components (A) comprising (i) at least one compound carrying two COOH groups or a derivative thereof (A1),
b) at least one OH group carrying component or mixture of components (B) comprising
(i) at least one compound carrying three OH groups selected from the group consisting of 1,3,5-tris(hydroxymethyl)isocyanurate, 1,3,5-tris(2-hydroxyethyl)isocyanurate, 1,3,5-tris(2-hydroxyisopropyl)isocyanurate, 1,3,5-tris(2-hydroxypropyl)isocyanurate and 1,3,5-tris(2-hydroxybutyl)isocyanurate (B1),
(ii) at least one compound carrying two OH groups selected from the group consisting of 1,1-bis(hydroxymethyl)-cyclohexane, 1,2-bis(hydroxymethyl)cyclohexane, 1,3-bis(hydroxymethyl)-cyclohexane, 1,4-bis(hydroxymethyl)cyclohexane, 1,1-bis(hydroxyethyl)-cyclohexane, 1,2-bis(hydroxyethyl)cyclohexane, 1,3-bis(hydroxyethyl)-cyclohexane and 1,4-bis(hydroxyethyl)cyclohexane (B2),
(iii) optionally at least one compound, oligomer or polymer carrying at least three OH groups, which is different from B1 (B3), and
(iv) optionally at least one compound, oligomer or polymer carrying two OH groups, which is different from B2 (B4),
and
c) optionally at least one compound carrying at least one OH group and at least one COOH group or a derivative thereof (C).

19. The polyester polyol of claim 17, wherein component A1 is at least one aliphatic or alicyclic compound carrying two COOH groups or a derivative thereof.

20. The polyester polyol of claim 19, wherein component A1 is cyclohexane-1,2-dicarboxylic acid or a derivative thereof.

21. The polyester polyol of claim 17, wherein component B1 is 1,3,5-tris(2-hydroxyethyl) isocyanurate.

22. The polyester polyol of claim 17, wherein component B2 is 1,4-bis(hydroxymethyl)cyclohexane.

23. The polyester polyol of claim 17, wherein the ratio of the sum of mol OH groups derived from components B1 and B2 to the sum of mol OH groups derived from all components B and C is in the range of 40% to 100%.

24. The polyester polyol of claim 17, wherein the ratio of mol OH groups derived from components B1 to the sum of mol OH groups derived from components B1 and B3 is in the range of 20% to 100%.

25. The polyester polyol of claim 17, wherein the ratio of mol OH groups derived from components B1 to mol OH groups derived from component B2 is in the range of 10% to 1000%.

26. A solution comprising at least one polyester polyol of claim 17 and at least one organic solvent.

27. An organic-solvent based two-component coating composition comprising
a) a first component (K1) comprising (i) at least one polyester polyol of claim 17, and (ii) optionally at least one polymer carrying more than one OH group, which is different from the polyester polyol of claim 17 (D)
and
b) a second component (K2) comprising (i) at least one compound, oligomer or polymer carrying more than one N═C═O group or blocked N═C═O group (F).

28. The two-component composition of claim 27, wherein component D is present, and is at least one (meth)acrylic polymer carrying more than one OH group.

29. The two-component composition of claim 27, wherein component F is at least one oligomer or polymer carrying more than one N═C═O group or blocked N═C═O group.

30. The two-component composition of claim 29, wherein component F is at least oligomer or polymer carrying more than one N═C═O group and comprising (i) at least one unit independently derived from the group consisting of aliphatic and alicylic compounds carrying at least two N═C═O groups, and (ii) at least one isocyanurate structural unit.

31. The two-component composition of claim 29, wherein component F has an N═C=content of 5 to 40%.

32. An article coated with the composition of claim 27.
